(19) United States
(12) Patent Application Publication
(10) Pub. No.: US 2021/0125294 A1
(43) Pub. Date: Apr. 29, 2021

(54) SYSTEMS AND METHODS FOR IDENTIFYING POTENTIAL REAL ESTATE BUYERS

(71) Applicant: XOME HOLDINGS LLC, Lewisville, TX (US)

(72) Inventors: John-David Tidwell, Allen, TX (US); Shekhar Vemuri, Chandler, AZ (US); Satya Latha Mudiam, Chandler, AZ (US); Jason Yates, Tempe, AZ (US)

(21) Appl. No.: 17/077,522

(22) Filed: Oct. 22, 2020

Related U.S. Application Data
(60) Provisional application No. 62/925,079, filed on Oct. 23, 2019.
(60) Provisional application No. 63/024,829, filed on May 14, 2020.

(51) Int. Cl. G06Q 50/16; G06Q 30/02; G06F 16/2455; G06N 20/00

(52) U.S. Cl. CPC G06Q 50/16; G06Q 30/0205; G06Q 40/02; G06N 20/00; G06F 16/2455

(57) ABSTRACT

Systems and methods for identifying a potential buyer of real estate from real estate transaction public records, comprising identifying two or more real estate transaction public records that include matching buyers and different property addresses; identify real estate listings having at least some transaction attributes matching those of the two or more real estate transaction public records; and identifying the buyer included in the two or more real estate transaction public records as a potential buyer of property associated with the real estate listing(s). Systems and methods for identifying a potential buyer of real estate from real estate transaction public records and matching the potential buyer with an available real estate listing, comprising identifying contact information for a potential buyer selected from a plurality of real estate transaction public records; and notifying the potential buyer of available real estate listing(s) having matching transaction attributes.

CROSS-REFERENCE TO RELATED APPLICATION(S)

This application claims the benefit of and priority to U.S. Provisional Application No. 63/024,829, filed May 14, 2020, and U.S. Provisional Application No. 62/925,079, filed Oct. 23, 2019, all of which are hereby incorporated by reference in their entirety for all purposes.

### TECHNICAL FIELD

The present disclosure is directed systems and methods for matching sellers of real estate with potential buyers and, in particular, automatically identifying potential buyers using real estate transaction public records.

### STATEMENT REGARDING PRIOR DISCLOSURES BY THE INVENTOR OR A JOINT INVENTOR UNDER 37 C.F.R. 1.77(b)(6)

A blog entitled “Entity Resolution Case Study” was published on May 20, 2019 describing a portion of the subject matter of the present application (the “blog post”). One or more of the joint inventors named on this patent application invented the subject matter of the blog post. The author of the blog post obtained the subject matter disclosed directly or indirectly from one or more of the joint inventors named on the present application prior to publishing the blog post; specifically, the author of the blog post was part of a team engaged by Applicant to implement an associated commercial product and worked on coding. A copy of the blog post is provided on a concurrently filed Information Disclosure Statement.

### BACKGROUND

Current real estate sales techniques suffer from numerous deficiencies. For example, most real estate listing services require that both the buyer and the seller subscribe to the same service. This can limit both the buyer's and seller's options as the properties that are listed can only be found by limited searching within the listing services. Currently, buyers must search through multiple listing services to find properties that may be within their purchasing parameters. This is large investment in time, and often the buyers and sellers miss significant financial opportunities as time is wasted viewing properties that are not of interest. Therefore, there is a need for systems and methods to match buyers and sellers with a high degree of confidence that the match will lead to a successful transaction.

### SUMMARY

The present disclosure is directed to a system for identifying a potential buyer of real estate from real estate transaction public records. The system, in various embodiments, may include one or more physical processors and a storage device storing computer program instructions that, when executed by the one or more physical processors, cause the one or more physical processors to perform a method comprising: accessing a database containing a plurality of real estate transaction public records; analyzing the plurality of real estate transaction public records contained in the database to identify two or more real estate transaction public records that include matching buyers and different property addresses; comparing transaction attributes of the two or more real estate transaction public records with transaction attributes of each of a plurality of available real estate listings to identify those real estate listings having at least some transaction attributes matching those of the two or more real estate transaction public records; and identifying the buyer included in the two or more real estate transaction public records as a potential buyer of property associated with the real estate listing(s) identified as having at least some transaction attributes matching those of the two or more real estate transaction public records.

The real estate transaction records, in various embodiments, may include notices of deed transfers, mortgages, assessments, and default. The transaction attributes, in various embodiments, may include one or a combination of a property type, transaction type, purchase price, geographic region, and transaction date range.

In various embodiments, analyzing the plurality of real estate transaction public records contained in the database to identify two or more real estate transaction public records that include matching buyers and different property addresses may include: analyzing the plurality of real estate transaction public records for two or more real estate transaction public records containing similar buyer names and buyer addresses; consolidating the real estate transaction public records having similar buyer names and buyer addresses into a first cluster; assigning each real estate transaction public record of the first cluster a confidence score based on a degree of similarity amongst the buyer names and buyer addresses in the real estate transaction public records of the first cluster; consolidating those real estate transaction public records that were assigned a confidence score above a predetermined threshold into a second cluster; evaluating the real estate transaction public records of the second cluster for spelling variations in both buyer name and buyer address; and identifying those real estate transaction public records in which the buyer name varies over a period of time but is associated with the same buyer address, or in which the buyer address varies over a period of time but is associated with the same buyer name, as having matching buyers. In various embodiments, analyzing the plurality of real estate transaction public records contained in the database includes identifying two or more real estate transaction public records that include matching buyers, different property addresses, and transactions that occurred within a predetermined time frame.

Comparing transaction attributes, in various embodiments, may include comparing the two or more real estate transaction records to identify one or more matching transaction attributes, and analyzing the plurality of available real estate listings to identify one or more listings having at least some transaction attributes matching those of the two or more real estate transaction records.

The method, in various embodiments, may further include providing a dataset containing (a) the real estate transaction public records of the first cluster and (b) the associated confidence scores, to an active learning feature of a deduplication model to train the active learning feature to perform the step of analyzing the plurality of real estate transaction public records to identify two or more real estate transaction public records that include matching buyers and different property addresses. In various embodiments, the method may further include notifying the potential buyer of the one or more listings having transaction attributes matching those of the two or more real estate transaction public records. The method, in various embodiments, may include generating a user interface displaying at least the one or more listings having transaction attributes matching those of the two or more real estate transaction public records.

In another aspect the present disclosure is directed to method for identifying a potential buyer of real estate from real estate transaction public records. The method may being implemented by one or more physical processors and a storage storing computer program instructions that, when executed by the one or more physical processors, cause the one or more physical processors to perform the following method: accessing a database containing a plurality of real estate transaction public records; analyze the plurality of real estate transaction public records contained in the database to identify two or more real estate transaction public records that include matching buyers and different property addresses; comparing transaction attributes of the two or more real estate transaction public records with transaction attributes of each of a plurality of available real estate listings to identify those real estate listings having at least some transaction attributes matching those of the two or more real estate transaction public records; and identifying the buyer included in the two or more real estate transaction public records as a potential buyer of property associated with the real estate listing(s) identified as having at least some transaction attributes matching those of the two or more real estate transaction public records.

The real estate transaction records, in various embodiments, may include notices of deed transfers, mortgages, assessments, and default. The transaction attributes, in various embodiments, may include one or a combination of a property type, transaction type, purchase price, geographic region, and transaction date range.

In various embodiments, analyzing the plurality of real estate transaction public records contained in the database to identify two or more real estate transaction public records that include matching buyers and different property addresses may include: analyzing the plurality of real estate transaction public records for two or more real estate transaction public records containing similar buyer names and buyer addresses; consolidating the real estate transaction public records having similar buyer names and buyer addresses into a first cluster; assigning each real estate transaction public record of the first cluster a confidence score based on a degree of similarity amongst the buyer names and buyer addresses in the real estate transaction public records of the first cluster; consolidating those real estate transaction public records that were assigned a confidence score above a predetermined threshold into a second cluster; evaluating the real estate transaction public records of the second cluster for spelling variations in both buyer name and buyer address; and identifying those real estate transaction public records in which the buyer name varies over a period of time but is associated with the same buyer address, or in which the buyer address varies over a period of time but is associated with the same buyer name, as having matching buyers. In various embodiments, analyzing the plurality of real estate transaction public records contained in the database includes identifying two or more real estate transaction public records that include matching buyers, different property addresses, and transactions that occurred within a predetermined time frame.

Comparing transaction attributes, in various embodiments, may include comparing the two or more real estate transaction records to identify one or more matching transaction attributes, and analyzing the plurality of available real estate listings to identify one or more listings having at least some transaction attributes matching those of the two or more real estate transaction records.

The method, in various embodiments, may further include providing a dataset containing (a) the real estate transaction public records of the first cluster and (b) the associated confidence scores, to an active learning feature of a deduplication model to train the active learning feature to perform the step of analyzing the plurality of real estate transaction public records to identify two or more real estate transaction public records that include matching buyers and different property addresses. In various embodiments, the method may further include notifying the potential buyer of the one or more listings having transaction attributes matching those of the two or more real estate transaction public records. The method, in various embodiments, may include generating a user interface displaying at least the one or more listings having transaction attributes matching those of the two or more real estate transaction public records.

In yet another aspect, the present disclosure is directed to a system for identifying a potential buyer of real estate from real estate transaction public records and matching the potential buyer with an available real estate listing. The system may include one or more physical processors and a storage device storing computer program instructions that, when executed by the one or more physical processors, cause the one or more physical processors to perform a method including: accessing one or more databases containing a plurality of real estate transaction public records and a plurality of available real estate listings; analyzing the plurality of real estate transaction public records contained in the database to identify two or more real estate transaction public records that include matching buyers and different property addresses; identifying one or more transaction attributes of each of (a) the two or more real estate transaction public records identified as including matching buyers and different property addresses, and (b) the plurality of available real estate listings; comparing the transaction attributes of the two or more real estate transaction public records with the transaction attributes of each of the plurality of available real estate listings to identify those available real estate listings having at least some transaction attributes matching those of the two or more real estate transaction public records; identifying the buyer included in the two or more real estate transaction public records as a potential buyer of property associated with the available real estate listing(s) identified as having at least some transaction attributes matching those of the two or more real estate transaction public records; identifying contact information for the potential buyer; and notifying the potential buyer of the available real estate listing(s) having transaction attributes matching those of the two or more real estate transaction public records.

In various embodiments, analyzing the plurality of real estate transaction public records contained in the database to identify two or more real estate transaction public records that include matching buyers and different property addresses may include: analyzing the plurality of real estate transaction public records for two or more real estate transaction public records containing similar buyer names and buyer addresses; consolidating the real estate transaction public records having similar buyer names and buyer addresses into a first cluster; assigning each real estate transaction public record of the first cluster a confidence score based on a degree of similarity amongst the buyer names and buyer addresses in the real estate transaction public records of the first cluster; consolidating those real estate transaction public records that were assigned a confidence score above a predetermined threshold into a second cluster; evaluating the real estate transaction public records of the second cluster for spelling variations in both buyer name and buyer address; and identifying those real estate transaction public records in which the buyer name varies over a period of time but is associated with the same buyer address, or in which the buyer address varies over a period of time but is associated with the same buyer name, as having matching buyers.

### BRIEF DESCRIPTION OF THE DRAWINGS

FIG. 1 is a schematic view of a system for identifying potential real estate buyers according to an embodiment of the present disclosure.

FIG. 2 is a schematic view of data architecture and processing techniques according to an embodiment of the present disclosure.

FIG. 3 is a flowchart depicting a method for identifying potential real estate buyers according to various embodiments.

FIG. 4 schematically depicts various data staging, transformation, and modeling techniques applied to public records data and data from other sources according to an embodiment of the present disclosure.

FIG. 5 is a flowchart depicting an entity resolution process according to an embodiment of the present disclosure.

FIG. 6A depicts a user interface displaying an interactive map of available property listings according to an embodiment of the present disclosure.

FIG. 6B depicts a user interface displaying potential buyers matched with a given available property listing according to an embodiment of the present disclosure.

FIG. 6C depicts a user interface displaying various group members associated with a particular potential buyer according to an embodiment of the present disclosure.

FIG. 6D depicts a user interface displaying available property listings matched with a given potential buyer according to an embodiment of the present disclosure.

### DETAILED DESCRIPTION

Embodiments of the present disclosure are directed to systems and methods for identifying potential real estate buyers. More specifically, the present systems and methods may apply various data staging, transformations, modeling, and other processing techniques to public records associated with real estate transactions to automatically identify one or more persons or entities (referred to herein as “potential buyer(s)”) that may be interested in one or more property listings based on the potential buyer's prior purchases (also referred to herein as “purchasing history”). Data processing techniques of the present disclosure may be computerized and automated, thereby providing the ability to scour vast amounts of data for potential buyers having purchasing histories fitting any number of desired criteria and generate numerous, quality sales leads. Of particular advantage in that brokers, agents, and other users seeking to match buyers with sellers (broadly and collectively referred to herein as “brokers” for simplicity) can utilize the present systems and methods to identify potential buyers that may not necessarily be aware of or familiar with the broker and/or the broker's services/platform. For example, a broker may use the present systems and methods to identify potential buyers that are not registered on the broker's traditional online brokerage platform (e.g., an online auction platform) and facilitate the broker in contacting the potential buyer with available listings of likely interest to the potential buyer, thereby increasing the marketing reach of the broker, increasing brokered sales, and attracting new buyers to the broker's platform, as described in more detail herein.

Systems and methods described herein are used by a company for matching potential property buyers and sellers. In some embodiments, the system uses a combination of data sourcing; data staging, transformations, and modeling; entity resolution; user interface analytics; potential buyer identification; and potential buyer contact to facilitate a successful match.

In various embodiments, systems and methods of the present disclosure may not rely on one of either a buyer or seller, or both, belonging to a real estate subscription service. In some embodiments, potential buyers are identified without the buyer browsing through a selection of property, and/or without interacting with a website selling property. At a high level, matching occurs in some embodiments by way of the system determining a likely match between seller and prospective buyers using transaction attributes from a plurality of real estate transaction public records in combination with various aspects of the system. According to some embodiments, the system uses various data sources to aggregate information about individuals or companies into a buyer profile. The buyer profile can consist of a multitude of information: in some embodiments the buyer profile can include information about buying frequency, purchase price range, and purchase location.

Using the buyer profile, in some embodiments individuals and/or entities are then contacted to let them know that there is a property for sale that meets the buyer's interests. As will become more apparent from the following detailed disclosure, there is no need for a buyer and seller to belong to the same real estate subscription service to facilitate a match between buyer and seller.

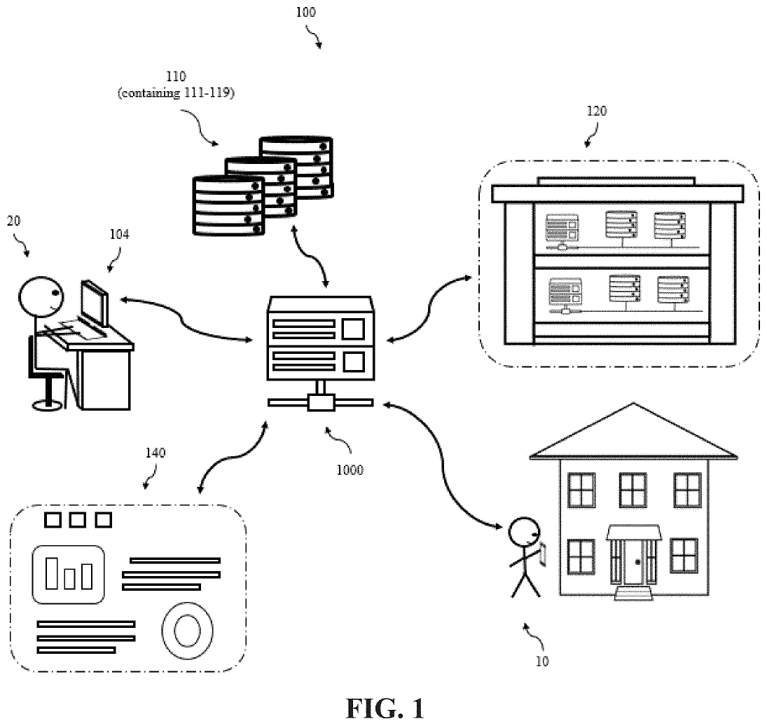

FIG. 1 is a schematic view of a representative system 100 for identifying potential real estate buyers 10. System 100, in various embodiments, may generally comprise a computer system 1000, one or more databases 110 containing raw data 111, and a data warehouse 120 in which the raw data 111 is combined and processed to identify potential buyers 10 based at least in part on each buyer's respective purchasing history, as later described in more detail. Computer system 1000, in various embodiments, may be configured to generate a user interface 140 (viewable, for example, on a computer 1040) for displaying information and reports about potential buyers 10, available property listings 114, and associated matches there between. When a match is identified, computer system 1000, in an embodiment, may provide broker 20 with sale lead information (e.g., the potential buyer's 10 contact information, as well custom sales pitch information to use during a sales call) while, in another embodiment, computer system 1000 may generate and send the potential buyer 10 an automated message (e.g., robocall), email, text message, or other correspondence containing information about matching listing(s) 114 and the broker's 20 platform and services. In various embodiments, computer system 100 may include one or more physical processors and a storage device storing computer program instructions that, when executed by the one or more physical processors, cause the one or more physical processors to perform the methods set forth herein.

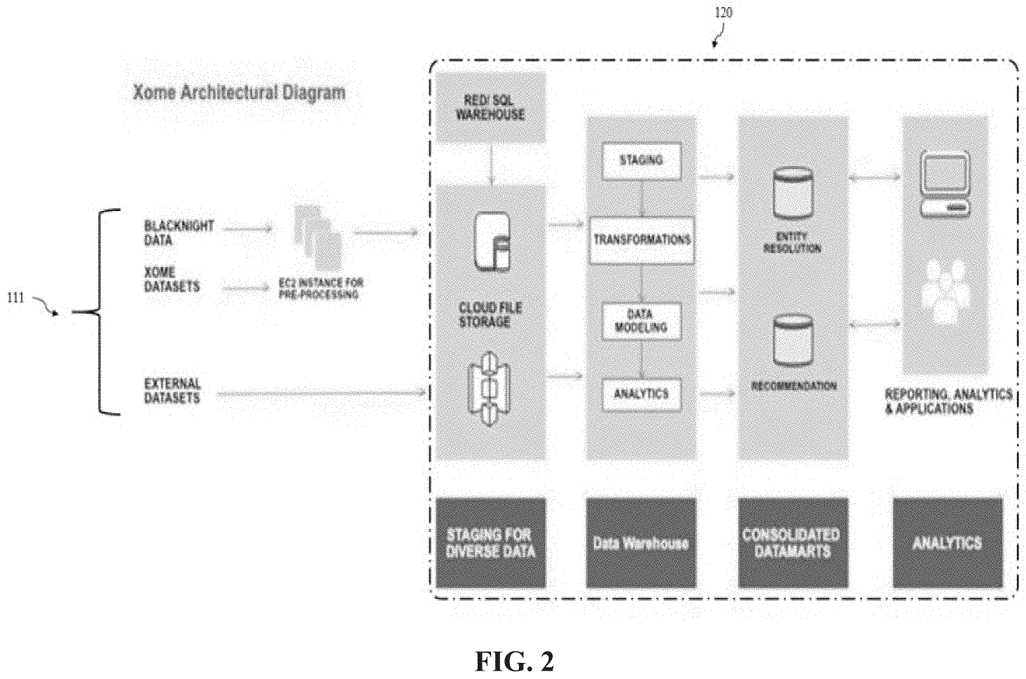

FIG. 2 depicts representative data architectures and processing techniques associated with data warehouse 120 of system 100. As shown in FIG. 2 and later described in more detail, raw data 111 from diverse sources (e.g., public records 112, active real estate listings 114, completed real estate transactions 116, and other sources 118) may initially be collected and staged in data warehouse 120. Once staged, processing techniques may be applied to transform at least some of raw data 111 to generate an organized data set 119 suitable for querying, modeling, and analytics to identify data associated with real estate transactions of interest. The resulting data may be consolidated for further analysis, such as entity resolution (later described) and generating recommendations as to possible matches between potential buyers 10 and available property listings 114.

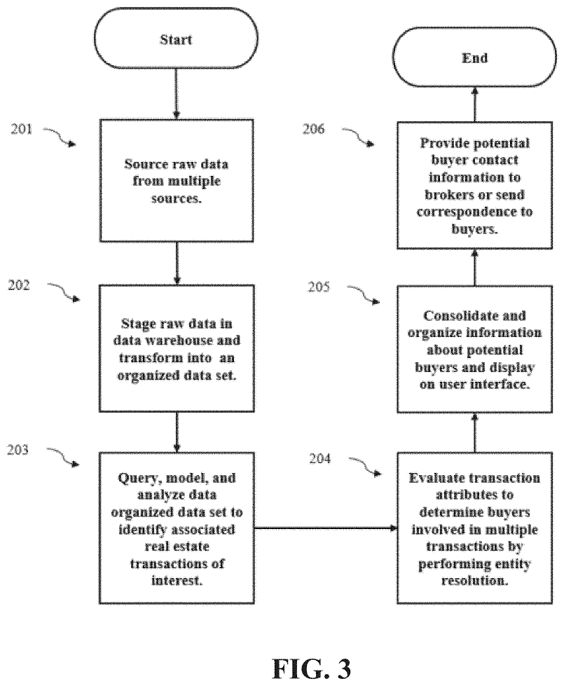

FIG. 3 is a flowchart depicting a computerized method for identifying a potential buyer 10 of real estate according to an embodiment of the present disclosure. The computerized method, in various embodiments, may be implemented using system 100 of FIG. 1 and the data architectures and processing techniques of FIG. 2. As shown in FIG. 3 and later described in more detail, the computerized method may begin at step 201 by sourcing raw data 111 from multiple sources such as public records 112, active real estate listings 114, completed real estate transactions 116, and other sources 118. At step 202, raw data 111 may be staged in data warehouse 120 and transformed to form an organized data set 119. At set 203, the organized data set 119 may be queried, modeled, and analyzed to identify data associated with real estate transactions of interest. At step 204, transaction attributes 113 (later described) such as buyer information and property location may be evaluated to determine when a particular buyer may have been involved in multiple real estate transactions despite differences in buyer information in a process referred to herein as entity resolution, which is later described in more detail. At step 205, information derived about one or more potential buyers 10 may be consolidated and organized for display in user interface 140, and transaction attributes associated with each potential buyer 10 may also be compared with listing attributes 115 (later described) associated with available property listings 114 to identify possible matches for subsequent communication to the respective potential buyer 10. At step 206 (which notably may occur at any one of many other points in the process such as, without limitation, between step 204 and 205), contact information for potential buyer(s) 10 may be obtained and provided to broker via user interface 140 or used to send correspondence to potential buyer(s) 10.

As used herein, “matching” can include, but is not limited to, identification of exact copies of information or data. A “match” in the context of comparing transaction attributes 113 and listing attributes 115 can include grouping purchase prices that are the same or within the same range as the defined query, or may be some percentage thereof. Those of ordinary skill understand that “matching” attributes include returning results defined by the boundaries of a particular query. The term “matching” is also intended to encompass the identification of partial matches between one or more sets of information or data. For example, a “match” in the context of entity resolution can include grouping buyers that have the same or similar spelling.

### Data Sourcing

Database(s) 110, in various embodiments, may include information concerning public records 112 associated with deed transfers, mortgages, assessments, and notice of default. Each such public record 112 may generally include information about the particular real estate transaction (referred to herein as “transaction attributes 113”), such as the parties, the transaction type (e.g., fee simple, foreclosure, short sale, mortgage), attributes of the property (e.g., location, size, zoning, improvements), financials (e.g., purchase price, property valuation), and other information typically provided in public records associated with real estate transactions. As shown in FIG. 2, in various embodiments, public records data may be sourced via subscription contract from a record locating platform such as Black Knight Data & Analytics, LLC (Black Knight), who aggregates data from over 3,000 county recorder and county assessor locales. Data from Black Knight or other providers may be retrieved via FTP or other suitable manner and transferred to a cloud storage service hosted by Amazon Simple Storage Services (AWS3) according to some embodiments. As later described in more detail, system 100 may use transaction attributes 113 derived from public records 112 to identify potential buyers 10, profile their respective purchase histories, and ultimately match potential buyers 10 with real estate listings 114 that are likely to be of interest to the potential buyers 10 based at least in part on their respective purchase histories.

Database(s) 110, in various embodiments, may include information concerning active real estate listings 114. Each such listing 114 may include information about the particular property and proposed transaction (referred to herein as “listing attributes 115”) including the transaction type (e.g., fee simple, foreclosure, short sale, mortgage), attributes of the property (e.g., location, size, zoning, improvements), financials (e.g., purchase price, property valuation), and other information typically provided in public records associated with real estate transactions. As later described in more detail, listing attributes 115 may be used by system 100 to help match a given real estate listing 114 with a potential buyer(s) 10 based on the buyer's 10 purchase history.

Database(s) 110, in various embodiments, may include information concerning completed real estate transactions 116. Unlike information from public records 112, information concerning completed real estate transactions 116 (referred to herein as “prior broker transactions 117”) may be proprietary and collected, for example, by a company that facilitates real estate transactions such as an online brokerage platform. As later described in more detail, system 100, in an embodiment, may be configured to reference prior broker transactions 117 to determine whether any of the potential buyer(s) 10 identified from public records 112 is already associated with—and thus, likely already a registered user—of real estate transaction services and/or platforms offered by broker 20. In such cases, system 100 may notify the broker 20 so that the broker 20 can engage the potential buyer 10 with marketing tactics reserved for its existing user base rather than with marketing tactics intended for attracting new users that may not be familiar with the company and its services/platforms. Additionally or alternatively, prior broker transactions 117 provide a useful dataset for training entity resolution models to identify when certain transactions from public records 112 were actually performed by the same buyer, despite situations in which the buyer's name may have been misspelled in public records 112 or in which a single buyer used different names (e.g., operated under a different legal entity) for each transaction, as later described in more detail. It should be recognized that while referred to as prior broker transactions 117, this dataset need not be one proprietary to and/or reflective of past transactions involving broker 20—any dataset from any source may be used for training entity resolution models so long as it is instructive as to aspects of the entity resolution process.

Database(s) 110, in various embodiments, may include information from other sources 118 such as lists of known banks, mortgage companies, and mortgage servicers identified through web searches of various regulatory entities and Core Based Statistical Area (CBSA) conversion tables provided by the US Department of Housing and Urban Development (HUD) as defined by The Office of Management and Budget (OMB) according to various embodiments.

In an embodiment, lists of known banks, mortgage companies, and mortgage servicers may be used to create the “Buyer is a Lender” flag according to some embodiments. This flag is critical because deeds are recorded for a variety of reasons, one being a foreclosure was completed and ownership transferred from debtor to lender. Such a transaction may not be meaningful to this process if the company is looking for true buyers, not intermediate financial institution deed owners because of foreclosure, because the lender did not “buy” the property. Sources 118 for this list may include one or more of: bank list from the IMF Quarterly Survey, national banks from the Office of the Comptroller of the Currency (OCC) website, federal branches and agencies (e.g., from OCC website), credit card banks (e.g., from OCC website), federal savings associations (e.g., from OCC website), credit unions (e.g., from NCUA.gov), FDIC Financial Institution Directory, list of Nationwide Mortgage Licensing System and Registry (NMLS) servicers (e.g., from the New York Department of Financial Services (NYDFS) website), list of NMLS mortgage bankers (e.g., from the NYDFS website). NYDFS may be used because NMLS does not provide lists directly. These lists may be revised or supplemented by broker 20 based on insight of buyers that are lenders or servicers, primarily because the name on the deed was a variation of their true legal name, or was not captured from the initial list.

Additionally or alternatively, CBSA/MSA conversion tables may be used in combination with public records 112 for geographic mapping and grouping. More specifically, public records 112 typically show the address of a property which can be used to group by zip code, city or state, and the conversion tables can use property zip code to aggregate to a Core Based Statistical Area (CBSA) or Metropolitan Statistical Areas (MSA), which is a geographic area larger than a city and generally recognized as a metropolitan area. For example, the Dallas-Fort Worth-Arlington, Tex., MSA is comprised of 415 zip codes and 145 cities into what we would commonly recognize as the DFW area.

### Data Staging, Transformation, and Modeling

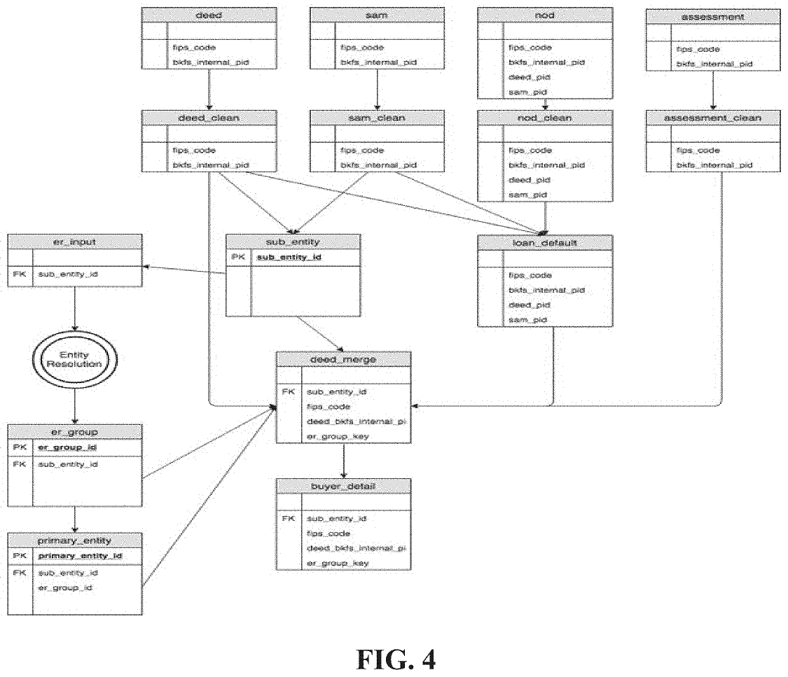

FIG. 4 schematically depicts various data staging, transformation, and modeling techniques applied to public records data 112 and data from other sources 114, 116, 118 in data warehouse 120 according to various embodiments of the present disclosure. Staging, transformations, and modeling may be performed using multiple software packages and techniques, as described in more detail below.

### Data Staging

Raw data 111, in various embodiments, may be sourced from multiple sources and staged for further processing in data warehouse 120. As shown in FIG. 4, various types of raw data 111 may be collected and staged from multiple sources such as:

1) Deed: Contains raw data collected, for Deed transactions, which contain data like, Federal Information Processing Standards (FIPS) code, property details, seller details, buyer details, legal details, sale details (example source file: Black Knight);

2) Stand alone mortgage (SAM): Shows lien holder(s) on the property. Data looks very identical to deed but contains SAM transactions (example source file: Black Knight);

3) Notice of Default (NoD): Used to derive purchase type of short sale. Data contains NoD records, that may or may not have matching deed and SAM; and

4) Assessment: Contains property characteristics from county tax assessor records. Assessment details of the property based on parcel number.

In some embodiments, raw data 111 may be staged in a cloud-based warehouse such as Amazon Web Services AWS3 cloud.

### Data Transformation

Because raw data 111 typically comes from multiple sources, data from one source will often be formatted and structured differently than data from another source, which can make it difficult to query the staged data and extract information from across the staged data in a useful manner. Therefore, after staging, raw data 111 may be transferred from the staging area (e.g., AWS3) into a data warehouse 120 such as a cloud native data warehouse designed for scale and flexibility to make it easier to query, cleanse and transform. For example, Snowflake™ is a SQL-based data warehouse that was built for cloud use with an architecture to handle all aspects of data and analytics. In some embodiments, system 100 may use Snowflake™ because of its advanced optimizations including automatic clustering, and because it processes tasks in a fraction of the time of conventional data warehouses, which is helpful due to the extensive number of records in public deed data. It should be recognized that, unless otherwise noted, references to Snowflake™ or any other branded product/service herein are merely references to non-limiting examples of the associated components (e.g., data warehouse 120 with respect to Snowflake™) described herein.

Data warehouse 120, in various embodiments, may be configured to cleanse raw data 111 as part of transforming the staged raw data 111 into organized data set 119. Cleansing can make it easier to understand and thereby associate data from across these diverse data sources. As shown in FIG. 4, in an embodiment, deed, SAM, NoD, and assessment data may be cleansed. Representative column cleansing tasks may include:

1) Date Value standardization (e.g., change all the dates to a standard date format (YYYY-MM-DD) that will be adopted by various components);

2) Column name changes from source columns to make them more descriptive; and

3) Consolidating multiple columns representing similar attributes into a single column representing a single attribute. Each county models its data differently and not all fields may initially be populated. For example, with respect to a recorder document number identifying a transaction at the country record level, some counties use recording document number to track a unique transaction while others use page and book number. Instead of using multiple columns to represent a single attribute, these fields may be consolidated into a single column. Consolidating multiple fields into a single field may facilitate identification of transactions that include multiple properties with a common attribute (e.g., sales price) for downstream transformations (e.g., sales price adjustments).

As shown in the “sub_entity” step of FIG. 4, after cleansing, data warehouse 120 may further transform the data by consolidating buyer and seller details from deed records and SAM records into a single table using flags to indicate if a record is a buyer, a seller, or any combination of these identifiers. This step may form a basis for entity resolution modeling, as later explained in more detail. Consolidating transaction details may enable linking data from buy-side to sell-side, and then is used in entity resolution for further aggregations. For example, as consolidated and linked, system 100 can now show how long an owner held property before selling and the difference between their buy price and sell price.

As shown in the “loan_default” step of FIG. 4, data warehouse 120 may match the latest notice of default activity to the matched deed record, either by linking directly to a deed, or indirectly to a deed via a direct linked SAM record. One of the attributes used to classify transaction by type of sale such as REO, foreclosure, short sale, or traditional.

System 100, in various embodiments, may additionally or alternatively perform further transformations according to reporting needs. In an embodiment, a goal of further transformations is to take raw public record data and transform to create useful categorizations which can be aggregated to build a profile of characteristics for a selected buyer. The buyer profile can, in turn, be used to match the selected buyer to available listings and ultimately recommend available listings with similar characteristics to those that the buyer has purchased previously. For example, in some embodiments, further transformations performed may include one or more of:

1) Sale price adjustments for multi-property transactions: In multi-property transactions, the sales price reflects the entire transaction. This transformation distributes the total price across each of the included properties. For example, if 25 properties are purchased in a single transaction for $2,500,000, the sale price adjustments may evenly distribute the $2,500,000 across the 25 properties for an average of $100,000 each. Of course, the sales price adjustments could distribute the $2,500,000 across the 25 homes in an uneven manner, for example, to account for any differences amongst the properties that may make some properties more valuable than others, if desired.

2) Deriving transaction types based on deed type, such as short sale, foreclosure, real estate owned (REO), and traditional sale: Transaction level attribute for identifying what types of purchases a buyer has previously made then used to match with corresponding attributes in the broker's internal datasets to recommend potential purchases based on a buyer's history.

3) Augmenting with external standard location data such as CBSA/MSA (e.g., map the ZIP code of a property to a CBSA/MSA): Standard, higher level geographic attribute used for segmentation or attribute matching larger than the county level. Provides a higher level geographic attribute where the hierarchy can be city→zip→county→CBSA→state. Provides identification of properties that reside outside of Federal CBSA/MSA definitions which are based on urban population and commuting. Allows for identification of more ‘rural’ properties that reside in areas outside of Federal CBSA/MSA definitions.

4) Property type classification: Leverage property-use categorizations from public record data to identify property types, such as single family residence (SFR), multi-family residence (MFR), commercial, or other type of property use to focus on specific property attribute values. For example, system 100, in an embodiment, may match potential buyers that have historically purchased residential properties with available SFR or MFR listings, while in another embodiment, system 100 may match potential buyers that have historically purchased commercial properties with available commercial listings.

5) Leveraging attributes from raw data 111 to perform matching between the two data sources, for example, based on one or more of price, location (e.g., address), and transaction type.

### Data Modeling

Once raw data 111 has been transformed into organized data set 119, data warehouse 120 can more easily query the data and generate useful information based on one or more modeling techniques. For example, data warehouse 120 may utilize modeling techniques to help: (i) identify and cluster those transaction records that involve the same or related buyers, even in cases where buyer information does not appear identical due to spelling variations or a common buyer's use of different legal entities for separate transactions (“entity resolution”), and (ii) power recommendations and match potential buyers 10 to available listings 114 based on each potential buyer's 10 respective purchasing history, as later described in more detail in the following sections.

### Entity Resolution Modeling

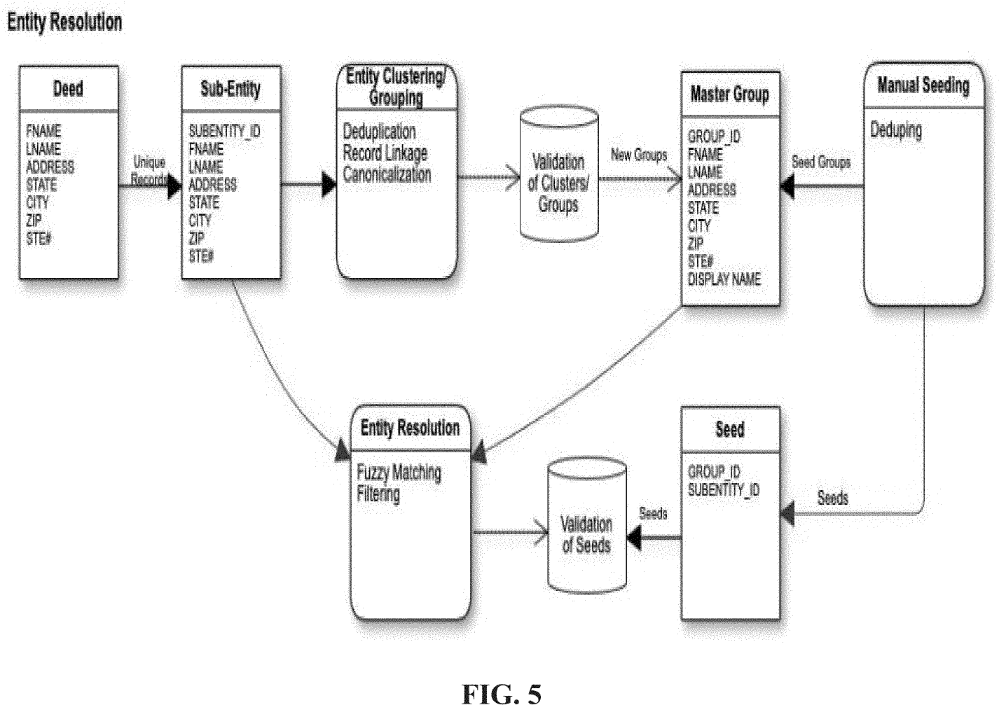

FIG. 5 is a diagram of the entity resolution process according to various embodiments. Entity resolution is significant because a single business may operate using multiple legal entities in some embodiments, additionally public records data is raw and inherently contains spelling variations and missing data points according to various embodiments.

In some embodiments, multiple techniques are applied to overcome these concerns and more accurately assemble the purchasing history of related entities. Two techniques are dedupe and fuzzy logic matching, where in some embodiments at least one of each are used by the system 100.

Entities are deduped using to consolidate multiple related purchasing entities into one cluster according to various embodiments. In some embodiments, machine learning techniques are used for de-duplication and entity resolution and dedupe is one such package that embodies machine learning. According to various embodiments, the active learning feature of the dedupe package is with the company's historical records, which contain relationships between registered users of broker's 20 platform/services and the entities that are named in contract documents. The machine learning algorithm backing the dedupe package now has enough knowledge to train and classify the remainder of the data accordingly into a master group according to some embodiments. Results of the dedupe are confidence scored on a scale between 0 and 1 which indicates how close the entities are matched, with 1 being an exact match and 0 being no similarity in some embodiments. In some embodiments, entities with an acceptable confidence score are clustered then passed to the second phase for further analysis.

When comparing records, according to various embodiments, rather than treating each record as a single long string, dedupe compares the records field by field. In some embodiments, this approach helps us leverage certain fields of records that help in identifying matches better than others. In some embodiments, dedupe lets broker 20 nominate the features they believe will be most useful. In some embodiments, the company creates a dictionary of feature vectors of records to train the model. In some embodiments, the company creates a dictionary of feature vectors of public records data 112 (e.g., as provided by Black Knight) to train the model.

In some embodiments, dedupe uses a process called active learning to create training data. This training data is a dictionary consists of pairs of vectors in two categories: 1) match; 2) distinct. According to some embodiments, in each category the company defines the relationship between the pairs. In some embodiments, active learning is an extended user-labeling session where the system provides inputs to label pairs to the training object. In some embodiments, the inputs are provided by someone who understands how to differentiate between entity records. According to various embodiments, the more examples dedupe gets trained on, the better predicates created by the algorithm for entity resolution.

According to some embodiments, the result of active learning process is the training data in the form of match and distinct categories with vectors of records. According to some embodiments, in each category the company defines the relationship between the pairs. In some embodiments, the pairs returned as match consist of records to be labeled as one: for example, consider address field pair (1520 market st, 1520 market street), the company configures the model to consider the records as the same. Distinct pairs consist of records that clearly are not the same: for example, consider address field pair (1502 market st, 1520 market street) are different (distinct).

In some embodiments, this labeled data is used for training the model that retained the relationships that it learnt from the data. In some embodiments, the system 100 uses the trained model to cluster similar records. In some embodiments, this happens in two steps:

1) First the input data is processed in multiple batches and are clustered accordingly with a clustered ID; and

2) Then the system recursively groups the multiple batches and the records are grouped by the last name and address to update the cluster id with the same cluster id (the cluster id of the last name/address with maximum frequency).

Even after the clustering process, the system 100 might still end up with many records without a proper cluster according to various embodiments. These records are assigned cluster id ‘−1’. The system then uses fuzzy string matching to compare the records with good clusters with the records with cluster id −1 and assign cluster ids in some embodiments. In some embodiments, the system uses the concept of Levenshtein distance. The Levenshtein distance between two words is the minimum number of single-character edits (insertions, deletions or substitutions) required to change one word into the other.

In some embodiments, fuzzy logic is applied within the dedupe package to further club together existing clusters to overcome spelling variations in both entity name and addresses. In some embodiments, fuzzy logic may be applied within Python™ using the Fuzzywuzzy Package. The two fields on which this action is primarily performed in some embodiments are entity name and address.

In some embodiments, the system 100 reviews exact and proximity matches across these two fields and generate clusters which allows the system to overcome data entry issues, such as same entities using different names over a period of time (but using the same business address), which results in a buyer database.

### Modeling for Reporting, Analytics, and Applications

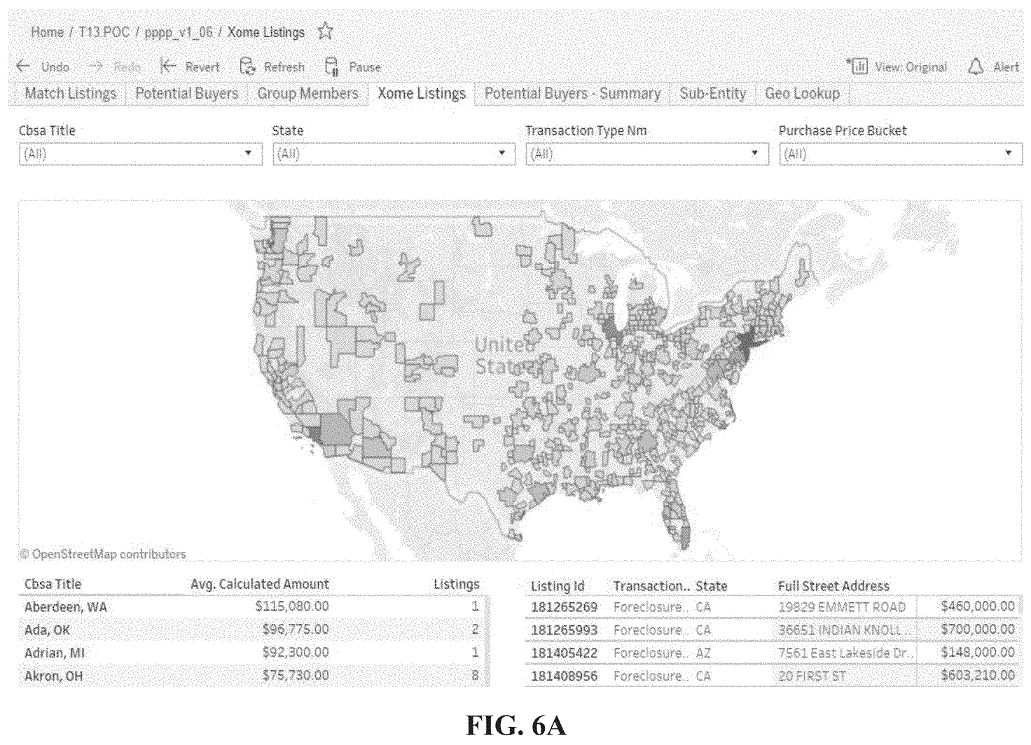

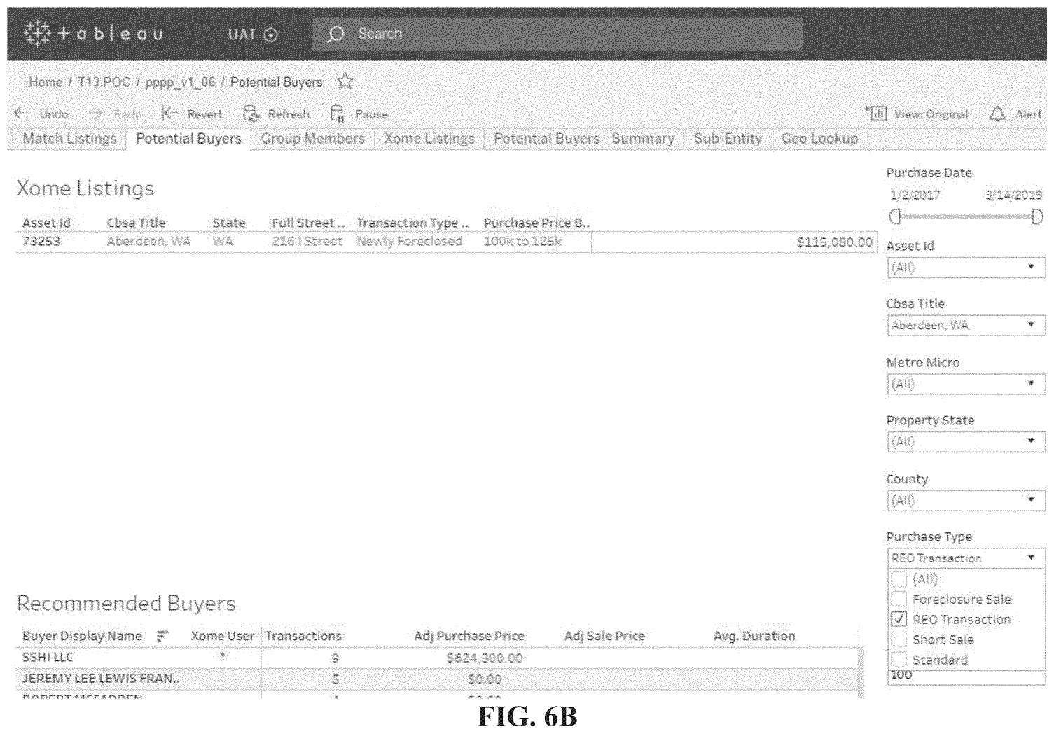

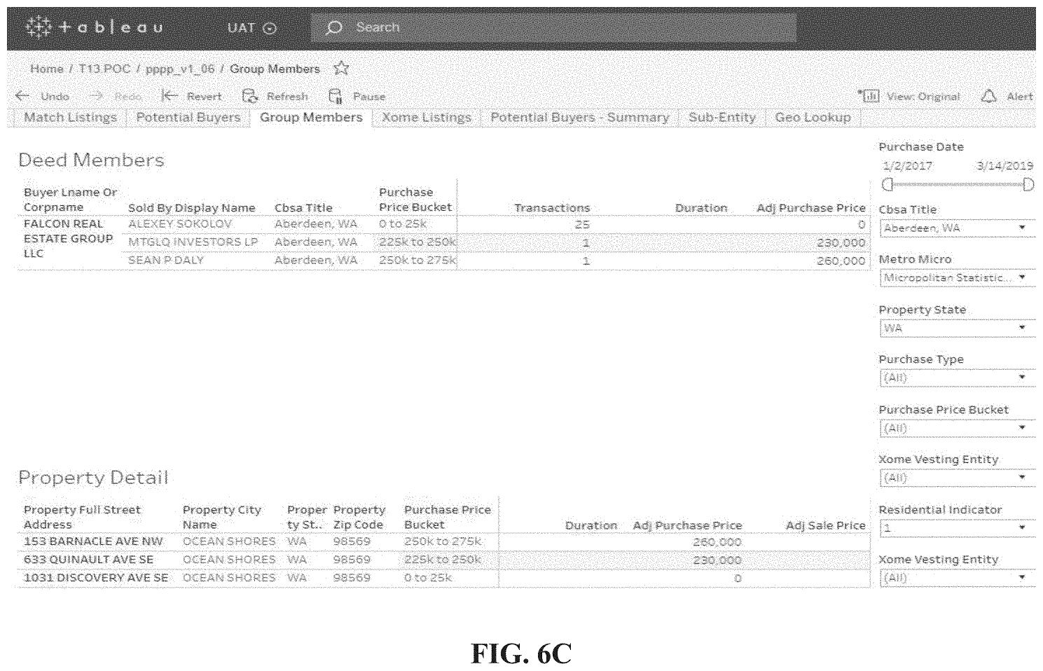

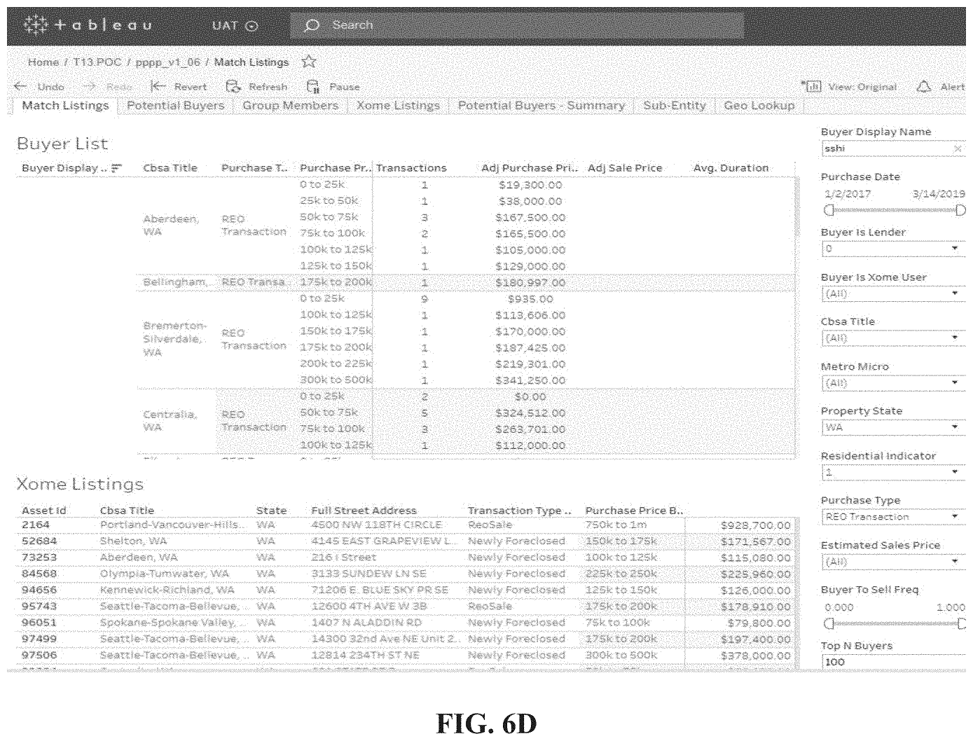

FIG. 6A, FIG. 6B, FIG. 6C, and FIG. 6D depict examples of information displayed on the user interface 140 according to some embodiments. In some embodiments, the user interface 140 provides access to the buyer database through a visualization software product. In some embodiments, primary access to the buyer database is through Tableau™, which is a business intelligence and data visualization software product available for licensing.

In some embodiments, broker 20 can mine the buyer database using one or more of the following example reports:

a) Company Listings—Identifies properties for sale on Xome.com through an interactive map.

b) Potential Buyers—Finds a recommended buyer for a selected property through broker 20 configurable parameters.

c) Group Members—Displays group members for the related entities associated with a recommended buyer (entity resolution creates clusters of related buyers which are referred to here as Group Members); and

d) Match Listings—Show all company listings that match the buying history of a selected recommended buyer entity obtained with broker 20 configurable parameters.

FIG. 6A is an example of an interactive map used to display company listings for properties for sale according to some embodiments. In some embodiments, the company listings report is refreshed nightly with listings from the company's website and graphically displayed on an interactive CBSA level heat map of the United States. In some embodiments, broker 20 may be shown a summary count of listings and average price by CBSA with property level detail listing within the selected CBSA. In some embodiments, further filtering ability is available through broker 20 configurable selection criteria for CBSA, state, transaction type, and price buckets.

FIG. 6B is an example of a potential buyers report according to various embodiments. In some embodiments, the potential buyers report recommends buyers for a specific company listed property or list of properties. In some embodiments, further filtering ability is available through broker 20 configurable selection criteria for purchase date, asset id, CBSA title, metro micro (OMB defines metropolitan and micropolitan statistical areas according to published standards), property state, county, purchase type, estimated sales price, top “n” buyers (defines the number of recommended buyers to display), residential indicator (derived from assessor records; distinguishes between residential and commercial property types), buyer is lender, buyer is a user of broker's 20 platform/services, and buyer to sell frequency (shows concentration of unique sellers from the buyer's history; can be used to filter out buyers that have high concentration of activity with the same sellers; generally useful for eliminating intra-company transfers between related legal entities, such as when a developer purchases lots then transfers to the builder who does the construction; also eliminates buyers who only transact with county tax assessors, which is typically indicative of buyers of delinquent tax liens).

FIG. 6C is an example of a group members report according to some embodiments. The group members report shows the deed member entities that were combined through the entity resolution matching process in some embodiments. In some embodiments, further filtering ability is available through broker 20 configurable selection criteria for purchase date, CBSA title, metro micro, property state, purchase type, purchase price bucket, company vesting entity, and residential indicator. In some embodiments, the report also shows purchase history for the group members with an additional section for previously purchased properties from the company.

FIG. 6D is an example of a match listing report according to various embodiments. In some embodiments, the match listings report shows active company listings recommended for a selected potential buyer. Further filtering ability is available through broker 20 configurable selection criteria for purchase date, buyer is lender, buyer is a user of broker's 20 platform/services, CBSA title, metro micro, property state, residential indicator, purchase type, estimated sales price, buyer to sell freq, and top n buyers.

System 100, in various embodiments, may perform potential buyer identification to establish contact name and phone number details. In some embodiments, potential buyers are typically LLC's and not individuals. In some embodiments, buyer identification is conducted through subscription data services like TransUnion, LexisNexis, or ThompsonReuters. In some embodiments, buyer identification is achieved by the system 100 using key words in internet search engines. In some embodiments, buyer identification is achieved by the system 100 using a combination of subscription data services and key word internet search engines. Ideally, in some embodiments, contact information is established via a waterfall of methods starting with automated API calls to one of the subscription data services, followed by manual research within one of the subscription data services, and lastly internet search engine research. According to various embodiments, potential buyers can be grouped into at least one of three categories with expected research methods as follows:

1) Potential buyers that are individuals or LLC's operating in their registered company name: generally, the easiest to locate and most likely accomplished through API calls with minimal additional research needed.

2) Smaller LLC's frequently that do not have a commercial presence in the name of the LLC: will likely not be successful via API call. Manual research connecting to an individual at the same address is likely to occur in one of the commercial subscription data services.

3) LLC's that exist only as legal holding vehicles within larger entities: more challenging to identify and not likely to be successful via API call. Manual research connecting to another company at the same address is likely to occur in one of the commercial subscription data services and supplemented by internet search engine research.

In some embodiments, contact information established for potential buyers is aggregated into a database for integration with a company customer tracking system and the customer service call center management software (e.g., Five9). The company outreach team also uses the match listings report when preparing for sales pitch to potential buyers according to some embodiments. For example, the match listing report may help educate a sales caller on size and market of contact prior to outreach and ease the cold call aspect of such calls by being familiar with the potential buyer.

### Entity Resolution Case Study

Nowadays data proves to be a powerful pushing force of the industry. Almost all companies representing diverse trade spheres seek to make use of the beneficial value of the data. Thus, data has become of utmost importance for those willing to make profitable decisions for their businesses. Following is a case study illustrating a representative example of various entity resolution methods described herein.

Entity resolution (ER) (sometimes referred to as deduplication) is the process of identifying and merging records judged to represent the same real-world entity. ER is a well-known problem that arises in many applications. The applications of ER are tremendous, particularly for the public sector and federal datasets related to health, transportation, finance, law enforcement, and antiterrorism.

For example, customer list in CRM data may contain multiple entries representing the same customer, but each record may be slightly different, e.g., containing different spellings or missing some information.

TABLE I
Sample CRM Data Snippet

| ID | Customer Name | City | State | Pincode |
|---|---|---|---|---|
| 1 | Rajeev Kumar Patil | Bangalore | Karnataka | 550048 |
| 2 | Rajeeev Kumar | Bangalore | Karnataka | 560048 |
| 3 | Rajeev Kummarr | Bangalore | Karnataka | 560048 |
| 4 | Rajev Kumarr Patil | Bangalore | Karnataka | 560048 |
| 5 | Rajjeev Kumar Patl | Bangalore | Karnataka | 560048 |

In the snippet depicted in Table I, based on the intuition, all the 5 entities refer to the same person—‘Rajeev Kumar Patil’ but we have separate entries in our database. We should have a way to point all these entities to a single record, that's where deduplication may come in handy. One such existing application that may be used to facilitate duplication efforts is Python library—dedupe, which hereinafter may be used as a representative example.

Data redundancy is a stumbling block in achieving business efficiency and can become a major headache for companies with plenty of data. The following case study is based on an auction platform that provides a large variety of real estate properties. The methods described herein leverage internal CRM data and external data which contains historical purchases/transactions to create a highly scalable AI-driven entity resolution algorithm across multiple historical data silos to eliminate redundancy and derive real business value.

One goal of this case study was to perform entity resolution on historical data to aggregate duplicate LLCs into the same entity. A second goal of the case study was to build a recommendation engine that identifies potential purchasers for properties that get listed on the auction platform where entity resolution output will be used.

Unfortunately, the problems associated with entity resolution are equally big—as the volume and velocity of data grow, inference across networks and semantic relationships between entities becomes increasingly difficult. To complicate things further, there can be spelling errors, transposed characters, missing values, and other anomalies.

In this case study, historical data was available from the last 10-12 years. On average, there may have been 1.5-2 million transactions each year, so there was a total of about 20 million transactions on which entity resolution was performed. We took the data from the project and heavily anonymized it. Entity resolution was performed at (LASTNAME OR ADDRESS) AND Exact STATE level, meaning entities with similar lastname OR address within the same state were designated to be part of the same cluster. LASTNAME encompasses last name in case of an individual and entity name for companies and organizations. Entity Resolution creates clusters for each category separately and efficiently.

### Entity Resolution Process

The representative entity resolution process was divided into 4 stages, as described in detail below.

1. Dedupe Clustering

Dedupe is a Python library for accurate and scalable data deduplication and entity-resolution. This library uses machine learning to perform de-duplication and entity resolution quickly on structured data. By default, the classifier is an L2 regularized logistic regression classifier.

Dedupe is a command line application which takes in human training data (active learning) by showing pairs of entities and asking if they are the same or different and then comes up with the best rules for a dataset to quickly and automatically find similar records, even with very large datasets. Active learning is the special sauce behind Dedupe. As in most of the supervised machine learning tasks, the major challenge is to find labeled data that the model can learn from. Dedupe scans the data to create tuples of records that it will propose to the user to label as being either match, not match or possible match. These uncertainPairs are identified using a combination of blocking, affine gap distance, and active learning.

Blocking is used to reduce the number of overall record comparisons that need to be made. Dedupe's method of blocking involves engineering subsets of feature vectors (these are called ‘predicates’) that can be compared across records. In this case study, the predicates might be things like:
the first five characters of LASTNAME
the first three digits of ADDRESS
a random 6-gram within the LASTNAME

Records are then grouped, or blocked, by matching predicates so that only records with matching predicates will be compared to each other during the active learning phase. The blocks are developed by computing the edit distance between predicates across records. Dedupe uses a distance metric called affine gap distance, which is a variation on Hamming distance that makes subsequent consecutive deletions or insertions cheaper.

The relative weight of these different feature vectors can be learned during the active learning process and expressed numerically to ensure that features that will be most predictive of matches will be heavier in the overall matching schema. As the user labels more and more tuples, Dedupe gradually relearns the weights, recalculates the edit distances between records, and updates its list of the most uncertain pairs to propose to the user for labeling.

Once the user has generated enough labels, the learned weights are used to calculate the probability (confidence score) that each pair of records within a block is a duplicate or not. In order to scale the pairwise matching up to larger tuples of matched records (in the case that entities may appear more than twice within a document), Dedupe uses hierarchical clustering with centroidal linkage. Records within some threshold distance of a centroid will be grouped together. The final result is an annotated version of the original dataset that now includes a centroid label (CLUSTER ID) for each record.

Following is a representative implementation of dedupe clustering used in the present case study.

Data Pre-Processing:
Normalization (convert all text to lower case, punctuations removal, strip white spaces and so on . . . )
Standardize PO BOX entries in ADDRESS field by maintaining a dictionary of synonyms and isolate them for later processing 107
Replace short form words using a dictionary mapping (rd road, hghwy highway . . . )
Records with missing STATE information are grouped together for later processing 108

Batch Size: 100K

Running dedupe on entire data (˜20M) is an insanely computationally heavy task so we processed chunks of 100K entities at a time after sorting the data at LASTNAME and ADDRESS level. Each batch of 100K entities takes approx. 3-4 Minutes to run on EC2 Instance (144 GB RAM machine). As this stage is computationally expensive with a requirement for huge memory, states with large volume of data such as FL, CA, TX, NY, MI, IL are processed separately and the output of all these batches is appended into a single file. This process of listing out large states is configurable and baked into the pipeline for easy orchestration.

Custom Labeled Pairs: 500 Examples of Each ‘Match’ and ‘Distinct’ Pairs

As dedupe relies on active learning (human labeled pairs) to create a model, we have provided additional manually curated labeled pairs to training object. The more examples dedupe object sees, the better predicates will be created which enhances the output of ER. We first let the system automatically select a minimum of 200 examples to learn from. Human intelligence is the key factor in selecting the best examples with nuances that we want the system to learn from. An additional 1000 examples are added using markPairs' object with 500 in each category (Match and Distinct).

2. Cluster Filtering

The output of stagel i.e. Dedupe Clustering adds ‘CONFIDENCE SCORE’, ‘CLUSTER ID’ to the input data. In this stage, we will filter entities where the ‘CONFIDENCE_SCORE’ is ≥0.5, basically filtering the entities in a cluster with good confidence to avoid false positives.

Additional parameters can be set to control the flow of the clusters through subsequent stages. By default, all the clusters created from dedupe stage go through Recursive Grouping and Fuzzy Matching stages. To bypass recursive grouping for a given cluster, right after Dedupe stage, flag EXCLUDE_GROUPBY has to be set to “1”. This is to retain the quality of the clusters and to minimize the size where multiple entities operate through same agent or multiple unrelated entities through same address etc.

3. Recursive Grouping

The output of stage2 i.e. Cluster Filtering is used as an input to stage3.

The entire data has been processed into multiple batches. Even after sorting the data, there is a possibility an entity with the same name/address could be part of different batch (edge case scenario) which results in two different CLUSTER_ID for similar entities.

Assuming a batch size of 100K, all the similar entities (LASTNAME: ‘BAYAREA BANK LLC’) are clustered into two separate clusters. To avoid this, Recursive grouping can be performed using both LASTNAME and ADDRESS at a time to update the CLUSTER_ID based on the maximum frequency recorded corresponding to values of LASTNAME/ADDRESS.

4. Fuzzy Matching

In computer science, fuzzy string matching is the technique of finding strings that match a pattern approximately (rather than exactly).

Fuzzywuzzy is a Python library for fuzzy string matching which uses Levenshtein Distance to calculate the differences between sequences in a simple-to-use package.

Following is a representative implementation of fuzzy matching.

Datasets:
Seed_data: Output of stage3 (good quality clusters)
Delta_data*: Input_data minus Seed_data

*Delt_ data will have entities with CLUSTER ID=−1 (non-clustered entities) and CONFIDENCE SCORE<0.5 Fuzzy Scorer:

Fuzzy Scorer:
fuzz.ratio: Compares the entire string similarity, in order.
process.extractOne: To find the best match for a string against a list of strings.

Approach:
Each entity of Delta_data is matched against all the entities of Seed_data and best matched (top1) is picked out and then assign this entity of Delta_data to Cluster_id of best matched.
The fuzzy string matching is done first on ADDRESS for all the Delta data entities and then for left-over entities, the matching was done on LASTNAME.
The cutoff score is taken ≥95 and ≥85 for ADDRESS and LASTNAME fuzzy matching respectively. These cutoffs were decided after multiple iterations by taking into account—% of False Positives, % Accuracy, and % Coverage.
After the 1st stage of fuzzy matching is completed, the matched entities from Delta_data becomes New_Seed_data and remaining entities (Delta_data Minus New_Seed_data) becomes New_Delta_data
The 2nd stage of fuzzy matching is executed between New_Seed_data and New_Delta_data

PO Boxes:
The PO Box records that were set aside in the early stages of data processing will go through Fuzzy Matching directly for high quality clusters.
The predicates made of the first three characters of address would have clustered all the PO Box entries into one, since they all start with “PO” in the dataset. Hence they bypass Dedupe, Filtering, and Recursive Grouping stages.
The common characters such as PO will be stripped and run through FuzzyMatching Address matching with a cutoff score set to 100 to generate high quality clusters.

Missing State:
Transactions with state information missing have to be processed carefully to ensure real world inter-state entities are not clustered together.
Fuzzy Matching is an NXN (N square) computation and even a half million of records with missing state information can lead to 250B computations.
Seed_data and Delta_data are same sets in this scenario and both of them will be sorted by Address first before the processing begins. Fuzzy string matching is performed on Address with cutoff score set to □98 to create quality clusters.
These clusters are flagged as non-state clusters and are not clubbed with clusters built on the State.

The final output of the entity resolution process of the present case study will be Output of Stage 3 (Clusters with high confidence created by Dedupe)+Output of Stage 4 (Fuzzy Matched Entities Stage 1st, Stage 2nd , PO Box records, and missing state records).

Output of the entity resolution is then merged with the public records and the data remodeled from a transaction model, where party a purchased from party b, to an ownership model, where party a acquired a property on a date and disposed of it, where applicable, at later date. Details from both ends of the transaction are aggregated into a single record with details such as net sales difference, ownership duration, purchase or sale type, or any other inherited or derived attributes from the transactions, geographic area, entity cluster, or entity cluster members.

Entity cluster management is available to propagate identifiers such as IS_LENDER or IS_PLATFORM_USER to all members of a cluster to provide better clarity in the visualization for matching a buyer to property or provide additional controls as part of entity resolution. An agent or servicer may provide services for multiple, unrelated entities such as with Fannie Mae or Freddie Mac servicing different financial institutions or multiple, unrelated entities may operate out of the same address such as in large metropolitan areas such as Chicago or New York City.

A prospective buyer can be matched to listed properties, or a listed property can be matched to prospective buyers, based on any combination of the geographic, entity, transactional, or time based attributes available. Eg—match using an entity based attribute where the buyer is an existing platform user, the listed property is of a specific transaction type and price, and the property is located in a CBSA where the user has previously made a purchase within the last 12 months.

Although method operations can be described in a specific order, it is understood that other housekeeping operations can be performed in-between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the system 100 has been described above in connection with particular embodiments and examples, the system 100 is not necessarily so limited, and that numerous other embodiments, examples, uses, modifications and departures from the embodiments, examples and uses are intended to be encompassed by the claims attached hereto. The entire disclosure of any patent or publication cited herein is incorporated by reference, as if each such patent or publication were individually incorporated by reference.

It is understood that the present disclosure is not limited in its application to the details of construction and the arrangement of components set forth in the description or illustrated in the drawings. Systems and methods of the present disclosure are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The disclosure is presented to enable a person skilled in the art to make and use embodiments of the systems and methods of the present disclosure. Various modifications to the illustrated embodiments will be readily apparent to those skilled in the art, and the generic principles herein can be applied to other embodiments and applications without departing from embodiments of the present disclosure. Thus, embodiments of the present disclosure are not intended to be limited to embodiments shown, but are to be accorded the widest scope consistent with the principles and features disclosed herein. The detailed description is to be read with reference to the figures, in which like elements in different figures have like reference numerals. The figures, which are not necessarily to scale, depict selected embodiments and are not intended to limit the scope of embodiments of the present disclosure. Skilled artisans will recognize the examples provided herein have many useful alternatives and fall within the scope of embodiments of the present disclosure.

What is claimed is:

1. A system for identifying a potential buyer of real estate from real estate transaction public records, the system comprising:
one or more physical processors; and
a storage device storing computer program instructions that, when executed by the one or more physical processors, cause the one or more physical processors to perform a method comprising:
accessing a database containing a plurality of real estate transaction public records;
analyzing the plurality of real estate transaction public records contained in the database to identify two or more real estate transaction public records that include matching buyers and different property addresses;
comparing transaction attributes of the two or more real estate transaction public records with transaction attributes of each of a plurality of available real estate listings to identify those real estate listings having at least some transaction attributes matching those of the two or more real estate transaction public records; and
identifying the buyer included in the two or more real estate transaction public records as a potential buyer of property associated with the real estate listing(s) identified as having at least some transaction attributes matching those of the two or more real estate transaction public records.

2. A system according to claim 1, wherein the real estate transaction records include notices of deed transfers, mortgages, assessments, and default.

3. A system according to claim 1, wherein analyzing the plurality of real estate transaction public records contained in the database to identify two or more real estate transaction public records that include matching buyers and different property addresses includes:
analyzing the plurality of real estate transaction public records for two or more real estate transaction public records containing similar buyer names and buyer addresses;
consolidating the real estate transaction public records having similar buyer names and buyer addresses into a first cluster;
assigning each real estate transaction public record of the first cluster a confidence score based on a degree of similarity amongst the buyer names and buyer addresses in the real estate transaction public records of the first cluster;
consolidating those real estate transaction public records that were assigned a confidence score above a predetermined threshold into a second cluster;
evaluating the real estate transaction public records of the second cluster for spelling variations in both buyer name and buyer address; and
identifying those real estate transaction public records in which the buyer name varies over a period of time but is associated with the same buyer address, or in which the buyer address varies over a period of time but is associated with the same buyer name, as having matching buyers.

4. A system according to claim 3, wherein the method further comprises providing a dataset containing (a) the real estate transaction public records of the first cluster and (b) the associated confidence scores, to an active learning feature of a deduplication model to train the active learning feature to perform the step of analyzing the plurality of real estate transaction public records to identify two or more real estate transaction public records that include matching buyers and different property addresses.

5. A system according to claim 1, wherein analyzing the plurality of real estate transaction public records contained in the database includes identifying two or more real estate transaction public records that include matching buyers, different property addresses, and transactions that occurred within a predetermined time frame.

6. A system according to claim 1, wherein the transaction attributes include one or a combination of a property type, transaction type, purchase price, geographic region, and transaction date range.

7. A system according to claim 1, wherein comparing transaction attributes includes:
comparing the two or more real estate transaction records to identify one or more matching transaction attributes, and
analyzing the plurality of available real estate listings to identify one or more listings having at least some transaction attributes matching those of the two or more real estate transaction records.

8. The system according to claim 1, wherein the method further includes notifying the potential buyer of the one or more listings having transaction attributes matching those of the two or more real estate transaction public records.

9. The system according to claim 1, wherein the method further includes generating a user interface displaying at least the one or more listings having transaction attributes matching those of the two or more real estate transaction public records.

10. A method for identifying a potential buyer of real estate from real estate transaction public records, the method being implemented by one or more physical processors and a storage storing computer program instructions that, when executed by the one or more physical processors, cause the one or more physical processors to perform the following method:
accessing a database containing a plurality of real estate transaction public records;
analyze the plurality of real estate transaction public records contained in the database to identify two or more real estate transaction public records that include matching buyers and different property addresses;
comparing transaction attributes of the two or more real estate transaction public records with transaction attributes of each of a plurality of available real estate listings to identify those real estate listings having at least some transaction attributes matching those of the two or more real estate transaction public records; and
identifying the buyer included in the two or more real estate transaction public records as a potential buyer of property associated with the real estate listing(s) identified as having at least some transaction attributes matching those of the two or more real estate transaction public records.

11. A method according to claim 10, wherein the real estate transaction records include notices of deed transfers, mortgages, assessments, and default.

12. A method according to claim 10, wherein analyzing the plurality of real estate transaction public records to identify two or more real estate transaction public records that include matching buyers and different property addresses includes:
analyzing the plurality of real estate transaction public records for two or more real estate transaction public records containing similar buyer names and buyer addresses;
consolidating the real estate transaction public records having similar buyer names and buyer addresses into a first cluster;
assigning each real estate transaction public record of the first cluster a confidence score based on a degree of similarity amongst the buyer names and buyer addresses in the real estate transaction public records of the first cluster;
consolidating those real estate transaction public records that were assigned a confidence score above a predetermined threshold into a second cluster;
evaluating the real estate transaction public records of the second cluster for spelling variations in both buyer name and buyer address; and
identifying those real estate transaction public records in which the buyer name varies over a period of time but is associated with the same buyer address, or in which the buyer address varies over a period of time but is associated with the same buyer name, as having matching buyers.

13. A method according to claim 12, further including providing a dataset containing (a) the real estate transaction public records of the first cluster and (b) the associated confidence scores, to an active learning feature of a deduplication model to train the active learning feature to perform the step of analyzing the plurality of real estate transaction public records to identify two or more real estate transaction public records that include matching buyers and different property addresses.

14. A method according to claim 10, wherein analyzing the plurality of real estate transaction public records contained in the database includes identifying two or more real estate transaction public records that include matching buyers, different property addresses, and transactions that occurred within a predetermined time frame

15. A method according to claim 10, wherein the transaction attributes include one or a combination of a property type, transaction type, purchase price, geographic region, and transaction date range.

16. A method according to claim 10, wherein comparing transaction attributes includes:
comparing the two or more real estate transaction records to identify one or more matching transaction attributes, and
analyzing the plurality of available real estate listings to identify one or more listings having at least some transaction attributes matching those of the two or more real estate transaction records.

17. The method according to claim 10, further including notifying the potential buyer of the one or more listings having transaction attributes matching those of the two or more real estate transaction public records.

18. The method according to claim 10, further including generating a user interface displaying at least the one or more listings having transaction attributes matching those of the two or more real estate transaction public records.

19. A system for identifying a potential buyer of real estate from real estate transaction public records and matching the potential buyer with an available real estate listing, the system comprising:
one or more physical processors; and
a storage device storing computer program instructions that, when executed by the one or more physical processors, cause the one or more physical processors to perform a method comprising:
accessing one or more databases containing a plurality of real estate transaction public records and a plurality of available real estate listings;
analyzing the plurality of real estate transaction public records contained in the database to identify two or more real estate transaction public records that include matching buyers and different property addresses;
identifying one or more transaction attributes of each of (a) the two or more real estate transaction public records identified as including matching buyers and different property addresses, and (b) the plurality of available real estate listings;
comparing the transaction attributes of the two or more real estate transaction public records with the transaction attributes of each of the plurality of available real estate listings to identify those available real estate listings having at least some transaction attributes matching those of the two or more real estate transaction public records;
identifying the buyer included in the two or more real estate transaction public records as a potential buyer of property associated with the available real estate listing(s) identified as having at least some transaction attributes matching those of the two or more real estate transaction public records;
identifying contact information for the potential buyer; and
notifying the potential buyer of the available real estate listing(s) having transaction attributes matching those of the two or more real estate transaction public records.

20. The system according to claim 19, wherein analyzing the plurality of real estate transaction public records contained in the database to identify two or more real estate transaction public records that include matching buyers and different property addresses includes:
analyzing the plurality of real estate transaction public records for two or more real estate transaction public records containing similar buyer names and buyer addresses;
consolidating the real estate transaction public records having similar buyer names and buyer addresses into a first cluster;
assigning each real estate transaction public record of the first cluster a confidence score based on a degree of similarity amongst the buyer names and buyer addresses in the real estate transaction public records of the first cluster;
consolidating those real estate transaction public records that were assigned a confidence score above a predetermined threshold into a second cluster;
evaluating the real estate transaction public records of the second cluster for spelling variations in both buyer name and buyer address; and
identifying those real estate transaction public records in which the buyer name varies over a period of time but is associated with the same buyer address, or in which the buyer address varies over a period of time but is associated with the same buyer name, as having matching buyers.
